(19) United States
(12) Patent Application Publication
(10) Pub. No.: US 2007/0124215 A1
(43) Pub. Date: May 31, 2007

(54) Virtual shopping with personal image environment

(76) Inventor: Lawrence D. Simmons JR., Bloomington, MN (US)

Correspondence Address: Mark A. Litman & Associates, P.A.;York Business Center, Suite 205, 3209 West 76th St,, Edina, MN, 55435, US

(21) Appl. No.: 11/472,159

(22) Filed: Jun. 21, 2006

Related U.S. Application Data
(60) Provisional application No. 60/788,786, filed on Apr. 3, 2006.
(60) Provisional application No. 60/740,689, filed on Nov. 29, 2005.

(51) Int. Cl. G06F 17/30

(52) U.S. Cl. 705/27

(57) ABSTRACT

A method of and system for assisting on-line purchaser evaluation of commercial items has at least: a user communicating on-line from a user processor with a server; the user processor providing digital image data on a user created digital image; the server providing digital image data of a multiplicity of specific commercial items that may be purchased by the user; the user processor importing at least one image of the multiplicity of specific commercial items; and superimposing that at least one image onto the user created digital image to assist the user in visualizing a combination of the at least one commercial item in a field comprising the user created digital image.

### RELATED APPLICATIONS

This application claims priority from U.S. provisional application Ser. No. 60/788,786 filed Apr. 3, 2006; which claims priority under U.S. provisional patent application Ser. No. 60/740,689, filed Nov. 30, 2005

### BACKGROUND OF THE INVENTION

1. Field of the Invention

The present invention relates to commercial practices, particularly commercial sales and consumer purchasing, and more particularly to sales assisted by viewing products on a monitor with a purchaser or agent providing at least a portion of the image content to assist in potential purchaser appreciation of a product.

2. Background of the Art

In 1997, it had been estimated that on-line sales in the U.S. would approach 5 billion dollars in a single year. By 2004, on-line sales during the holiday season between Thanksgiving and Christmas had reached nearly seventy billion dollars in the U.S. alone. The apportionment of sales between store marketing has gone from less than 1% to approximately 20% in that same time frame. There can be no denying the fact that on-line, computer-based sales have become a critical venue for retailers, wholesalers and consumers. There are many different reasons why this is so.

The Web is a “catalog of catalogs.” Today's online shoppers typically visit multiple sites, loading items into shopping carts as a convenient way to compare total costs, including shipping charges. The return-to-buy decision seems to be based on two general categories: price/availability and safety/trust. The length of time from initial visit to actual purchase measured during the tests shows that consumers do a great deal of evaluation in these categories before deciding where to buy. The delay varied from site to site depending on customer demographics, brand recognition, the number of competitors online, and average product price. There are some interesting statistics that support this reasoning.

Average Time from First Visit to Purchase

| | |
|---|---|
| 50% took more than 1 hour | 21% took more than three days |
| 40% took more than 3 hours | 14% took more than one week |
| 35% took more than 12 hours | 4% took more than two weeks |
| 28% took more than one day | |

Sample Test Results

| Time Delay | Competition | Product Description | Observations |
|---|---|---|---|
| 8 hr. 50 min. | Low | Infant products | Single SKU. Unique product. |
| 10 hr. 3 min. | Low | Wholesale building | Sells largely to small |
| | | supplies | contractors. |
| 14 hr. 51 min. | Med | Retail pharmacy | Low-priced products. Repeat |
| | | | prescription buyers. |
| 15 hr. 20 min. | Med | Specialty musical | Niche market. |
| | | instruments | Limited number of sellers. |
| 18 hr. 33 min. | Med | High-performance | Sells to primarily |
| | | auto parts | male customer database. |
| 20 hr. 25 min. | High | Sporting goods | Very competitive market |
| | | | focused on branded footwear |
| | | | and apparel items. |
| 21 hr. 4 min. | Med | Bicycling products | Sells on price. Competitive |
| | | and accessories | market with small number of |
| | | | large retailers and |
| | | | cataloguers. |
| 24 hr. 15 min. | Med | Metalworking tools | Niche market. High number |
| | | and supplies | of repeat buyers from an |
| | | | educated demographic. |
| 24 hr. 37 min. | Med | Tools and | Specialized products sold to |
| | | hardware goods | those who typically watch |
| | | | PBS' New Yankee Workshop |
| | | | show. |
| 24 hr. 51 min. | High | Home security products | Non-exclusive product SKUs. |
| 25 hr. 53 min. | High | Logo'ed lapel pins | Low priced and widely |
| | | | available. |
| 25 hr. 53 min. | High | PC games | Highly competitive, |
| | | | price-conscious market. |
| 26 hr. 45 min. | High | Gourmet health foods, | Products available on many |
| | | nutritional supplements | Web sites. |
| 27 hr. 38 min. | High | Marine parts and | New and used parts and |
| | | accessories | accessories sold through |
| | | | online parts database. |
| 28 hr. 37 min. | High | Luxury personal items | High price point and selling |
| | | | to a typically risk- |
| | | | averse demographic. |
| 59 hr. 40 min. | Very | Consumer electronics | Highly competitive, price- |
| | High | | conscious market. Shopping |
| | | | search engines critical to |
| | | | driving traffic in this |
| | | | market. |

Studies have produced findings regarding shopping behavior that point to both motivators and barriers to online shopping. They clearly indicate that for those who comparison shop the most, trust factors can act as strong motivators when present. Conversely, they can also be strong barriers when absent. Contrary to the popular notion, these factors can be the deciding factor for a large portion of shoppers. Two key recommendations for converting shoppers into buyers are: creating a comfort zone for comparison shoppers, and moving the focus from shopping cart abandonment to site abandonment. Site designers need to make the shopping experience more informative, and the sense of safety more memorable, in order to influence those who abandon their carts not to completely abandon the site later when it comes to deciding where to buy.

It is also important to note that each product type has its own features and specialties that must be addressed to satisfy customers that are unique to that product area. The general persona of the customer must be addressed in the site, and the format of the site (both in imagery, ambience, user format and style) should be attractive to the widest variety of user. Where the user is likely to be less computer literate as compared to other classes of users, the format must be designed in a manner that is extremely user friendly.

Published U.S. Patent Application No. 20020177982 (Boulouednine) describes a computer-assisted showroom display used by a consumer for lighting plans for illuminating a space. An electronic display is provided of a room showing a plurality of areas thereof. Selection by the consumer of any one from among the plurality of areas is enabled, and then selection by the consumer of any one from among a plurality of lighting arrangements available for illuminating the selected area is enabled. The consumer is enabled to repeat the area selection and lighting arrangement selection for all of the plurality of areas. The room is displayed as illuminated by the combined effect of illuminating all of the plurality of areas with the lighting arrangements respectively selected therefore, so that the overall effect of the combination of lighting arrangements in all the areas of the room is simulated as realistically as possible. The consumer can thus find the best overall lighting plan. The system provides its own selection of background images for various rooms, and the user selects lighting systems for display on a room chosen from the selection.

Published U.S. Patent Application No. 20050071256 (Singhal) describes a fit system on a global computer network that enables, (i) an apparel designer to provide apparel data to the fit system, (ii) a merchant interface function that enables the apparel data to be made available to the merchant's server displaying prior art apparel web pages, (iii) a customer of the apparel merchant, using a client computer connected to the global computer network with the ability to shop the apparel merchants to execute a fit program in the client and displays a fit web page when the customer clicks a Try-it-on link displayed next to the display of the apparel on the merchant's web page, and (iv) a customer interface function that enables the customer to interact with the features of the Fit web page to be able to provide customer size data and select the apparel size, fit preference and be displayed images overlaid with numerical and visual fit indicators that enable the customer to judge the fitting of the available sizes of the apparel.

### SUMMARY OF THE INVENTION

A processor based, on-line system is provided wherein a central server provides virtual selections for specific classes of commercial objects, an internet customer/user accesses the central server, the customer user provides their own unique environment imagery, the accessed virtual selections are imposed upon the customer/user unique environment imagery, and the customer/user visualizes the selections in a personal environment to assist the customer/user in the selection of particular commercial objects. The system and practice is uniquely amenable to certain household products, particularly objects with significant 2-dimensional symmetry, such as rugs, tables, chairs, desks, bookcases, windows, and the like.

### BRIEF DESCRIPTION OF THE FIGURES

FIG. 1 shows a schematic of a system useful in the practice of the technology described herein.

FIG. 2 shows a screen shot of a practice of the present technology with rugs as the commercial product being viewed.

FIG. 3 shows a flow diagram of a method of commercial practice within the generic disclosure of technology herein.

FIG. 4 shows a second schematic of a system useful in the practice of the technology described herein.

FIG. 5 shows a third schematic of a system useful in the practice of the technology described herein.

FIG. 6 shows a fourth schematic of a system useful in the practice of the presently described technology.

FIG. 7 shows a second screen shot of a commercial embodiment of the present technology.

### DETAILED DESCRIPTION OF THE INVENTION

The technology described herein comprises a method of assisting on-line purchaser evaluation of commercial items. The process includes

a user communicating on-line from a user processor with a server;

the user processor providing digital image data on a user created digital image;

the server providing digital image data of a multiplicity of specific commercial items that may be purchased by the user;

the user processor importing at least one image of the multiplicity of specific commercial items; and

superimposing that at least one image onto the user created digital image to assist the user in visualizing a combination of the at least one commercial item in a field comprising the user created digital image.

The method may include steps wherein after viewing a first specific commercial item in the visualized combination, the digital image of the first commercial item is replaced with a second digital image of a second commercial item. In one embodiment, the user provided digital image comprises a digital image of a room within property owned by the user. The method may provide the digital image of the at least one commercial item as a rug, table, chair, cabinet, shelves, painting, or bed. The method is preferably practiced wherein an original digital image of the commercial item, such as the rug was captured (either by the user or professionally) and the image data placed on the server and the user then superimposes an image of the rug on the user created commercial image. This may be effected with virtual rotation of the image of the rug to effect perspective of the combination.

A system for enabling visualization of commercial items on a digital image provided by a user may comprise:

a user processor with monitor;

a server;

on-line communication support between the user processor and the server;

the server communicatively associated with a database of digital images of commercial items;

the user processor storing at least one digital image of a room that was downloaded by the user onto the user processor from a source other than the server; and

the user processor having executable software that enables communication with the server to receive and display digital images of commercial items and superimposed or combine at least one of the digital images of commercial items onto the digital image of the room downloaded by the user.

It is contemplated that the invention will be implemented with a computerized stem that would typically include a personal computer, a keyboard and/or a mouse, a monitor, and one or more speakers. The operating system is preferably WINDOWS, UNIX, LINUX, Mac OS or other available operating system, and a browser such as Internet Explorer, AOL or Netscape Navigator is used. In particular, the invention has been developed for the latest generations of internet browsers (i.e. versions 4.0, 5.0, 6.0. 7.0. 8.0 and 9.0 and higher) and some operations require “Flash/Shockwave” as a plug-in (available from Macromedia) for the browser. This plug-in is already included in Internet Explorer 5.0. Some data storage capacity on a computer-readable medium is useful. A computer-readable medium is any article of manufacture that contains data which can be read by a computer, or a carrier wave signal carrying data that can be read by a computer. For example, code corresponding to the computer program and/or databases to enable execution of the various required computerized operations in accordance with the invention may be stored and distributed on magnetic media, such as floppy disk, flexible disk, hard disk, reel-to-reel tape, cartridge tape and cassette tape; optical media, such as CD-ROM and writable compact disk; and paper media, such as punched cards and paper tape; memory chips such as a RAM, a PROM, an EPROM, a FLASH-EPROM; or on a carrier wave signal received through a network, wireless network, or modem, including radio-frequency signals and infrared signals.

The term “consumers” as used herein refers to homeowners, business owners, lessors, decorators and anyone else involved with purchase and recommendation of commercial items for placement within rooms.

The term “room” as used herein refers to any space which is confined by at least one wall and a cover (e.g., including a porch and awning combination) and preferably a location confined by four walls and a ceiling. Such space may be relatively interior to or exterior of a private residence, a commercial building or an industrial building, for example.

The term “commercial item” as used herein refers to any appliance or commodity that can be placed, positioned, located or installed in a room.

An embodiment of the invention is implemented as relying on communication over the Internet and is aimed at conveniently helping consumers to develop ideas for installation and selection of commercial items for homes or offices, for example. Thus, although the implementation of this technology can take various other forms, as pointed out above, the following discussion will focus on using the Internet, although it is to be understood that this is being done without in any way intending to limit the scope of the invention to this approach.

Before proceeding to describe the detailed implementation of the invention, an overview of what features are made available to the consumer and how these can be used is presented. The computerized system is utilized to present the consumer with an electronic display of a simulated room having suitable furnishings and illuminated by a lighting arrangement. This is referred to herein as a virtual showroom feature (also referred to herein for convenience just by the term “virtual showroom” or just “room”). The virtual showroom, which is an image provided by the user, preferably as an actual picture of a room that the user is specifically attempted to accessorize with furnishings, especially such as rugs. The room may be any room in a house, such as a living room, dining room, kitchen, bathroom and bedroom. The invention enables the consumer to virtually step into or compare any of these rooms and then try out different consumer items.

The use of this system with rugs is particularly simplified as the majority of rugs has two or three way symmetry and may be readily transposed, positioned, rotated or put into precise perspective with existing dimensional control software.

There may be any number of rug selections (being used as a preferred example of consumer items) available as options in each room. The system may also limit the display of rugs displayed by information provided by the user that provides limiting parameters, such as size, color, shape, pattern type and the like. In doing this, the server will sift through the images available and match the parameters from the selection available. There are of course many different ways of designing, experiencing and understanding the consumer items.

By clicking on one of the room choices, the following screen contents appear:

1. a rotating 360.degree. panoramic view of the selected room, and

2. a plan view which corresponds to the panoramic view of the room, with possibly multiple areas for rug placement being identified thereon.

When the invention displays the panoramic view or other view created by the user of the selected room, the orientation and size of this view can be controlled with instrumentality, such as the mouse, as if it were controlling a video camera. If the bedroom is selected, for example, the panorama rotates sequentially to three different areas, such as a sleeping (e.g. a bed), a dressing area (e.g. a dressing rable and a storage area (e.g. a closet).

By clicking on one of the areas in the plan view, the corresponding perspective view thereof is shown in a new display which at first appears as the selected area from the selected perspective. On the screen, adjacent the image, may be listed, ordered or otherwise provided the proposed selections made available by the server. The user selects the appropriate rug for examination, places the rug in a position desired, adjusts the rug, etc. The system may automatically orient the rug as would be expected (e.g., parallel to the floor and parallel to the edges of the wall. When one of the arrangements is selected, a picture of the full image of the rug lain on the floor is displayed along with a controller, which may be capable of rotating the rug, or even adjusting the color of the rug, if additional rugs of the same style in different color are available. Additionally, a lighting function may be provided to adjust the color tones from different lighting or different times of the day.

By using the panorama for panning around the room after the rug arrangements are selected, one can study the combined effect in the room from different perspectives. This is in fact a primary advantage of the virtual showroom. It can simulate the overall effect of the combination of consumer item arrangements in all the areas of the room as realistically as possible so that the consumer can find the overall solution that best suits his needs.

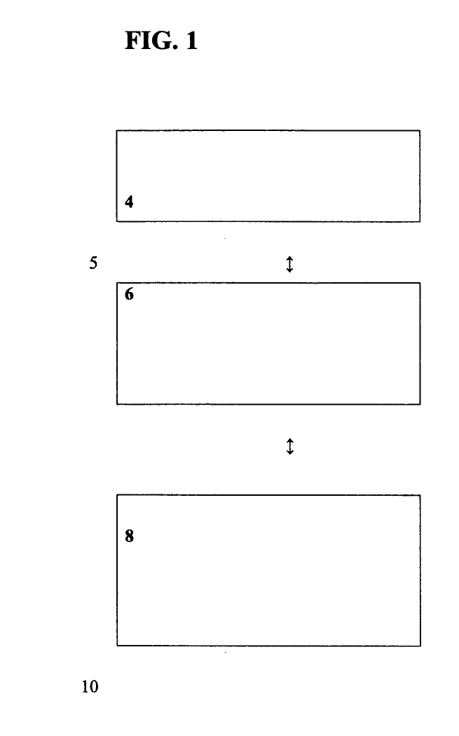

FIG. 1 shows a schematic of a system 2 useful in the practice of the technology described herein comprising the elements of the user processor 4, communication network 6, server 8, etc.

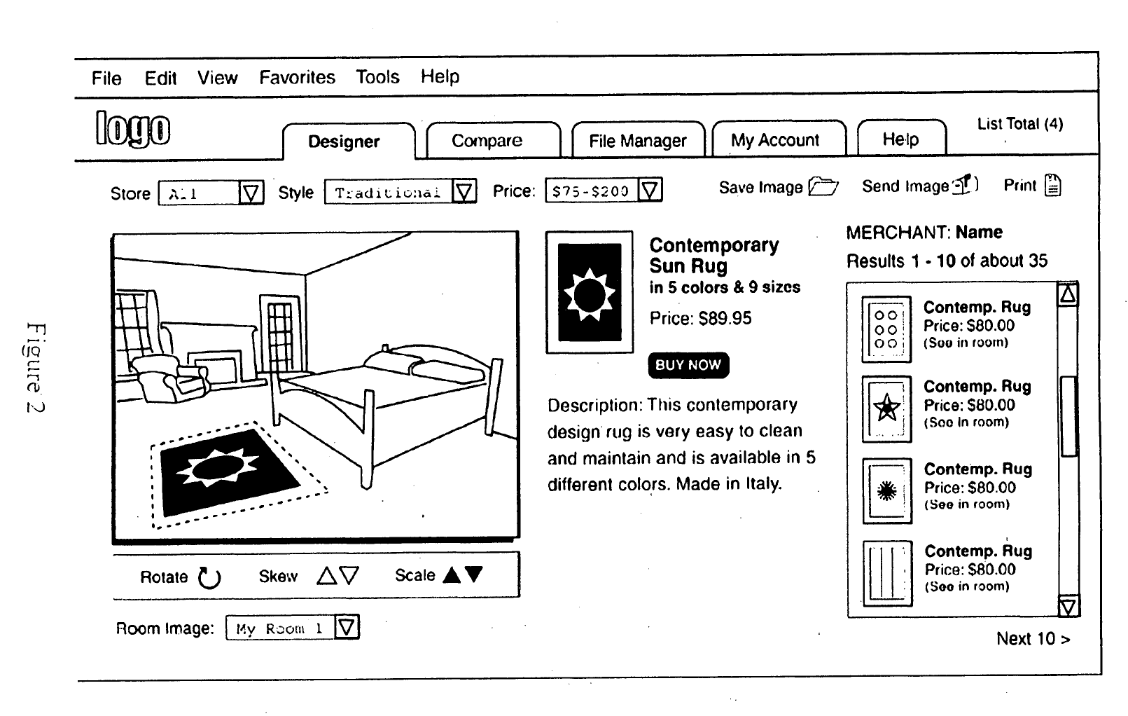

FIG. 2 shows a screen shot of a practice of the present technology with rugs as the commercial product being viewed.

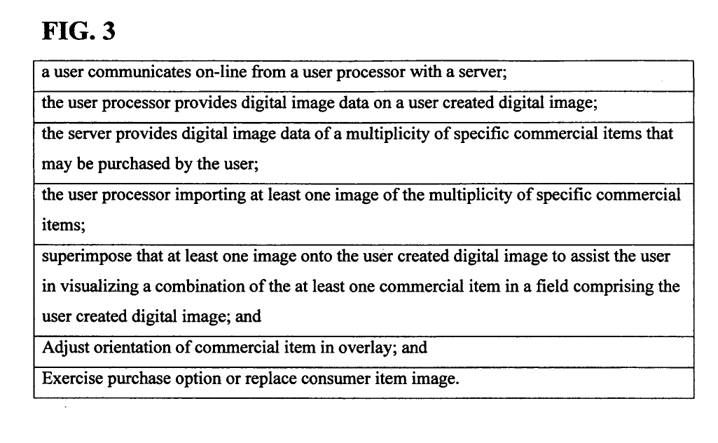

FIG. 3 shows a flow diagram of a method of commercial practice within the generic disclosure of technology herein.

Turning now to FIG. 3, when operation of the invention is initiated, such as by the user processor 4 accessing the appropriate website with server 8, the consumer's computer screen displays various buttons that can be selected by, for example, the click of a mouse. As used herein, the term “buttons” refers to the actual display of a button-like icon, touch screen points, attachable image elements as well as to hypertext. This is depicted in FIG. 2 in that the consumer can select from among buttons that enable access to the above-mentioned glossary, explanations, and any one of the listed virtual showrooms or specific consumer items. The system may be linked through the server to different consumer item providers, such as major or small home supply or furniture stores, local rug stores, malls, warehouses, catalogue sales and the like. If a virtual showroom has been selected by clicking on the appropriate button, then the next step determines which particular room or consumer item has been selected.

Once a particular room and particular item has been selected, the next step generates on the computer screen a juxtaposed/overlain display of the consumer item digital image on the room view. Such computer screen combination of images is depicted in FIG. 2.

The underlying screen portion depicts a plan view of the selected room, simultaneously an overlain screen portion depicts a panoramic view of the consumer item (e.g., rug) in the selected room. This view may be rotated to simulate perspectives of the rug and room from different angles so that comparisons of the rug with different room features may be made. The rug itself may also be rotated, as by clicking the mouse with the cursor positioned on the rug. Rotation can be continued manually by positioning and activating functions with the cursor. The same effect can also be achieved by using keyboard keys that are appropriately identified.

Screen areas show a listing of the various rugs available in the virtual showroom function. Each of these rugs can be clicked on at any time to switch the screen shown in FIG. 2 from the currently selected rug to a different one. The rugs may be identified by numbers or other identifiers, including technical descriptions of the formal rug type.

When one of the rugs is selected, as the consumer clicks on it, to find additional information, if available, pricing and even conclude the purchase of the rug over the internet at that time.

The screen may also contain “PRODUCT INFORMATION” or direct access buttons that can be clicked on by the consumer at any time.

Various other features can be added to those described above. For example, consumers can be given access to an extensive database of specialized dealers where all products of a particular manufacturer can be bought, and even further support is provided. Also, a storage function can be provided to collect information in the form of text and image corresponding to selections made by the consumer as well as other information that has been accessed in the course of proceeding through the above-described steps of the invention. The information is stored and, if desired, printed.

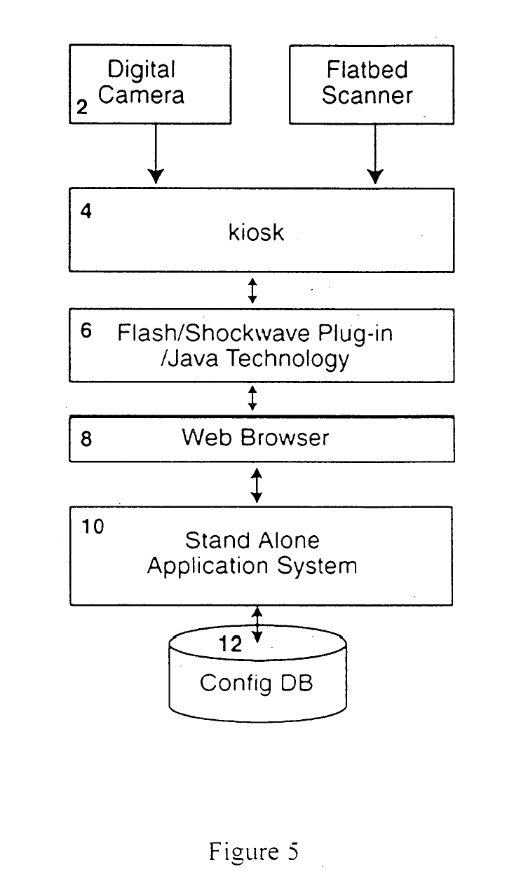

FIG. 5 shows a third schematic of a system useful in the practice of the technology described herein. A digital camera 2′ or flat bed scanner 3 may provide the image (through the smart chip or download) into a commercial kiosk 4a (e.g., at a mall) and the data is forwarded via a Flash/Shockwave Plug-In/Java technology 6′ through a web browser 8′ to a stand alone application system 10a operating through a configuration database 18. These type of system can be positioned within a distal location for walk-by use, for example, in a mall, shopping center, galleria, store and the like.

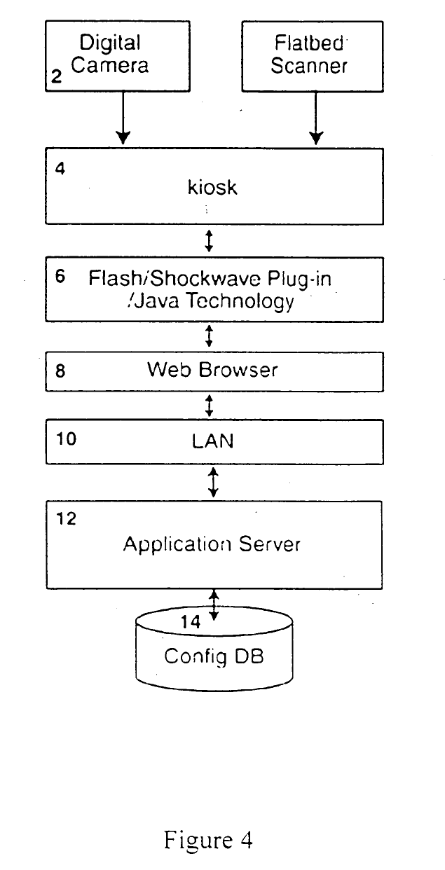

FIG. 4 shows a second schematic of a system useful in the practice of the technology described herein. A digital camera 2′ or flat bed scanner 3 may provide the image (through the smart chip or download) into a commercial kiosk 4a (e.g., at a mall) and the data is forwarded via a Flash/Shockwave Plug-In/Java technology 6′ through a web browser 8′ through a large area network 10b operating through an application server 12b to a configuration database 14. These type of system also can be positioned within a distal location for walk-by use, for example, in a mall, shopping center, galleria, store and the like.

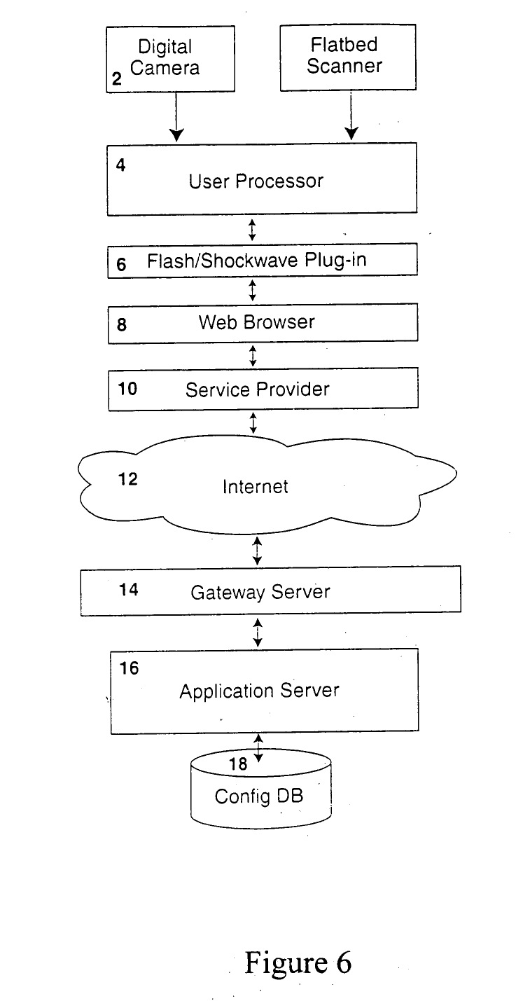

FIG. 6 shows a fourth schematic of a system useful in the practice of the presently described technology. A digital camera 2′ or flat bed scanner 3 may provide the image (through the smart chip or download) into a user processor 4 and the data is forwarded via a Flash/Shockwave Plug-In/Java technology 6′ through a web browser 8′ to a service providing site 10b operating through the internet 12 to a gateway server 14 then to an application server 16 and then to a configuration database 18. These types of system can be used from a personal computer at home or wireless connection at a store.

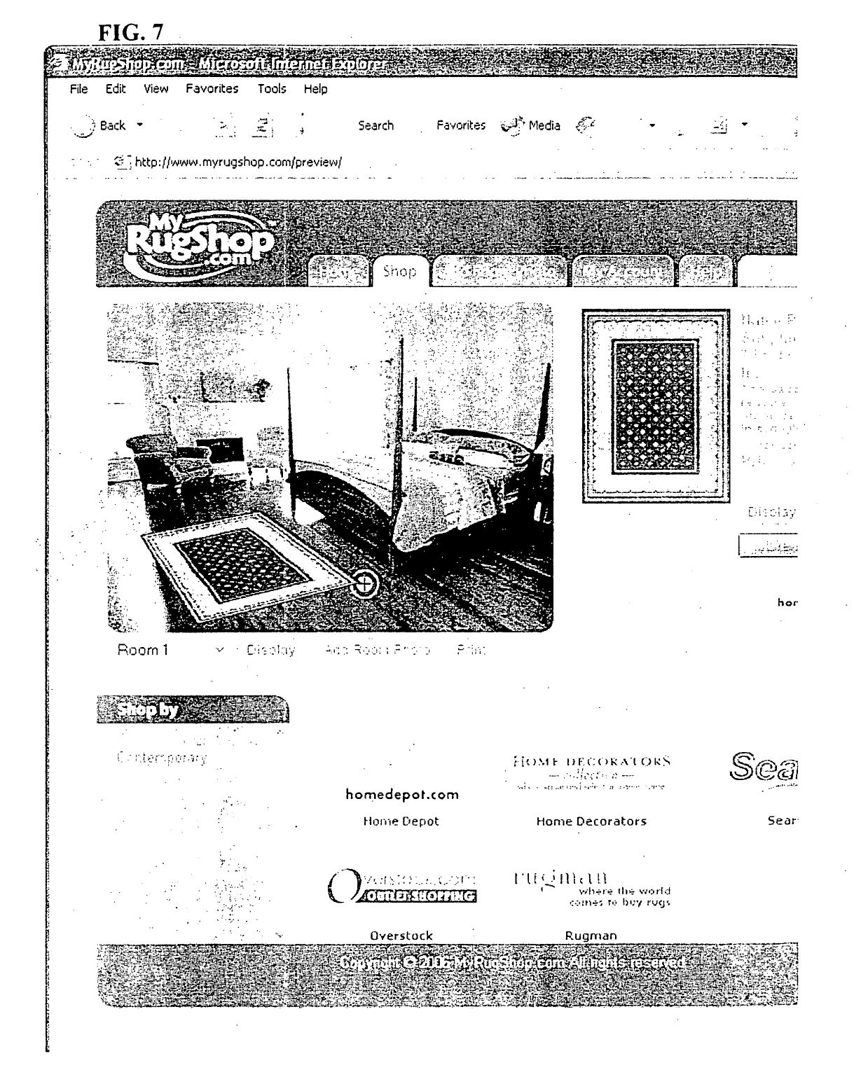

FIG. 7 shows a second screen shot of a commercial embodiment of the present technology. It is of interest to note in this regard, that where the merchant is identified, this is not necessarily a direct point of sale icon, but rather may be only an advertising portal through which the user/viewer may be placed into contact with a potential sales site. For example, as each sample of product is placed on the screen, the system may enable an identification of the sales location (by way of a business or e-mail address) where the product may be available, or provide a hyperlink text to the website for the owner (potential seller) of the product. The viewer/user may then make whatever contact or obtain whatever information is desired with respect to the owner/seller of the product being viewed on the website of this technology. In this regard, multiple sellers may have their individual products placed on the present technology system, and then the individual user may appropriately contact whatever owner/seller desired with regard to specific products displayed. Alternatively, the user may select a specific supplier/seller, and view products from only that supplier seller, and then make the appropriate commercial contact with that specific supplier seller, preferably through the present technology system, or by other appropriate means.

Of course, the specific number of virtual showrooms, the number of areas in each room, and the number of consumer items arrangements in each area is a matter of engineering choice and each could be readily increased or decreased. Also, the panoramic view could show the combined effect of all the selected lighting arrangements, with each being set to a desired light intensity rather than being at full intensity. All of these and other such variations are intended to fall within the scope of the present invention as defmed by the following claims.

What is claimed:

1. A method of assisting on-line purchaser evaluation of commercial items comprising:
a user communicating on-line from a user processor with a server;
the user processor providing digital image data on a user created digital image;
the server providing digital image data of a multiplicity of specific commercial items that may be purchased by the user;
the user processor importing at least one image of the multiplicity of specific commercial items; and
superimposing that at least one image onto the user created digital image to assist the user in visualizing a combination of the at least one commercial item in a field comprising the user created digital image.

2. The method of claim 1 wherein after viewing a first specific commercial item in the visualized combination, the digital image of the first commercial item is replaced with a second digital image of a second commercial item.

3. The method of claim 1 wherein the user provided digital image comprises a digital image of a room within property owned by the user.

4. The method of claim 3 wherein the digital image of the at least one commercial item comprises a rug.

5. The method of claim 4 wherein an original digital image of the rug was captured and placed on the server and superimposing an image of the rug on the user created commercial image is effected with virtual rotation of the image of the rug to effect perspective of the combination.

6. A system for enabling visualization of commercial items on a digital image provided by a user comprising:
a user processor with monitor;
a server;
on-line communication support between the user processor and the server;
the server communicatively associated with a database of digital images of commercial items;
the user processor storing at least one digital image of a room that was downloaded by the user onto the user processor from a source other than the server; and
the user processor having executable software that enables communication with the server to receive and display digital images of commercial items and superimposed or combine at least one of the digital images of commercial items onto the digital image of the room downloaded by the user.
